(19) United States
(12) Patent Application Publication
(10) Pub. No.: US 2026/0192238 A1
(43) Pub. Date: Jul. 9, 2026

(54) BLAST FURNACE GAS PRESSURE SWING ADSORPTION CARBON DIOXIDE CAPTURE SYSTEM COUPLED WITH COMPRESSED ENERGY STORAGE

(71) Applicants: Institute of Process Engineering, Chinese Academy of Sciences, Beijing (CN); Hebei Chuangjie Environmental Protection Engineering Co., Ltd., Shijiazhuang City (CN)

(72) Inventors: Tingyu ZHU, Beijing (CN); Yangyang GUO, Beijing (CN); Ruizhuang ZHAO, Shijiazhuang City (CN); Lei LUO, Beijing (CN); Guoping GAO, Shijiazhuang City (CN); Kang WANG, Shijiazhuang City (CN)

(21) Appl. No.: 19/437,436

(22) Filed: Dec. 31, 2025

(30) Foreign Application Priority Data
Jan. 7, 2025 (CN) 202510021988.8

(51) Int. Cl. B01D 53/053; B01D 45/02; B01D 46/02; B01D 50/20; B01D 53/04; C21B 7/22; F27B 1/18; F27D 17/10; F27D 17/22

(52) U.S. Cl. CPC B01D 53/053; B01D 45/02; B01D 46/02; B01D 50/20; B01D 53/0438; B01D 53/0446; B01D 53/0462; C21B 7/22; F27B 1/18; F27D 17/10; F27D 17/22; B01D 2257/30; B01D 2257/504; B01D 2257/80; B01D 2258/0283; B01D 2259/40052; B01D 2259/65; C21B 2100/44; C21B 2100/64

(57) ABSTRACT

A blast furnace gas pressure swing adsorption carbon dioxide capture system coupled with compressed energy storage is provided. The system includes a dust removal unit, a dry desulfurization device, a temperature swing adsorption (TSA) dehydration device, a first carbon dioxide pressure swing adsorption (PSA) adsorption device, a first compressor, a second carbon dioxide PSA adsorption device, a second compressor, a second heat exchanger, a third heat exchanger, a carbon dioxide high-pressure storage tank, a fourth heat exchanger, an expansion power generation device and a fifth heat exchanger connected in sequence.

### CROSS-REFERENCE TO RELATED APPLICATIONS

This application claims priority to Chinese Patent Application No. 202510021988.8, filed on Jan. 7, 2025, the contents of which are hereby incorporated by reference.

### TECHNICAL FIELD

The present disclosure belongs to the technical field of adsorption and energy storage, and specifically relates to a blast furnace gas pressure swing adsorption carbon dioxide capture system coupled with compressed energy storage.

### BACKGROUND

Blast furnace gas is a by-product generated during the steel production process. The blast furnace gas contains a large amount of CO₂. As global requirements for greenhouse gas emission reduction continue to increase, how to effectively capture and utilize CO₂ in blast furnace gas has become an important challenge facing the steel industry. Pressure swing adsorption (PSA) is a widely used gas separation technology. PSA has been extensively applied in carbon capture demonstration projects in domestic and international industries such as petroleum, chemical, and natural gas, and may be used for CO₂ capture from blast furnace gas. Pressure swing adsorption carbon capture technology offers advantages such as non-corrosiveness to equipment, long adsorbent cycle life, simple process, high degree of automation, and good environmental benefits. However, conventional PSA processes face challenges such as high energy consumption, low separation efficiency, and large equipment volume. The challenges limit the effectiveness of PSA technology in large-scale CO₂ capture applications.

With the global energy structure transformation and the increasing proportion of renewable energy, power systems are facing new challenges. The intermittent and fluctuating nature of renewable energy imposes higher demands on grid stability and reliability. Compressed energy storage technology may effectively mitigate output fluctuations of renewable energy, improve grid stability and reliability, and demonstrates broad application prospects in areas such as grid peak shaving, renewable energy grid integration, and distributed energy systems. In the industrial sector, compressed energy storage may also be combined with waste heat utilization and residual pressure recovery technologies to further enhance energy utilization efficiency. However, compressed energy storage technology still faces some challenges in practical applications, mainly including the need to improve system efficiency, further reduce costs, and address synergistic integration with other energy technologies. Therefore, developing innovative compressed energy storage systems, particularly integrated systems that may be combined with other energy utilization processes, has become one of the key research directions.

Innovative solutions that combine compressed energy storage technology with industrial processes (such as blast furnace gas treatment and CO₂ capture) may provide new pathways for industrial energy conservation and emission reduction while addressing the inherent limitations of compressed energy storage, holding significant practical significance and application value. Compressed air energy storage (CAES) is a large-scale energy storage technology with enormous potential, but it also faces issues such as low energy density, limited system efficiency, and site selection constraints, requiring further optimization and improvement. Integrating CO₂ capture with compressed energy storage technology is expected to achieve synergistic effects and improve the overall efficiency of the system.

### SUMMARY

The purpose of the present disclosure is to provide a blast furnace gas pressure swing adsorption carbon dioxide capture system coupled with compressed energy storage and an operation method for this system. The blast furnace gas pressure swing adsorption carbon dioxide capture system coupled with compressed energy storage proposed by the present disclosure has significant advantages. This system achieves synergy between carbon dioxide capture and compressed energy storage through energy integration, utilizing the pressure energy and thermal energy of blast furnace gas. Through heat recovery and pressure energy utilization, the overall system efficiency is significantly improved and costs are reduced. Furthermore, this system may flexibly adjust the carbon dioxide capture and energy storage processes according to grid demands, enhancing system flexibility. The innovative coupled system provided by the present disclosure may not only effectively solve the carbon dioxide emission reduction problem in the steel industry, but also support the large-scale application of renewable energy, possessing important theoretical significance and practical application value.

To achieve the above purpose, the present disclosure provides the following technical scheme.

One technical scheme of the present disclosure is to provide a blast furnace gas pressure swing adsorption carbon dioxide capture system coupled with compressed energy storage, including: a dust removal unit, a dry desulfurization device, a temperature swing adsorption (TSA) dehydration device, a first carbon dioxide pressure swing adsorption (PSA) adsorption device, a first compressor, a second carbon dioxide PSA adsorption device, a second compressor, a second heat exchanger, a third heat exchanger, a carbon dioxide high-pressure storage tank, a fourth heat exchanger, an expansion power generation device and a fifth heat exchanger connected in sequence;
where the dust removal unit is connected to a jacket of the TSA dehydration device, and a first shut-off valve is arranged between the dust removal unit and the TSA dehydration device;
a second shut-off valve is arranged between the dust removal unit and the dry desulfurization device;
a third shut-off valve and a first heat exchanger connected in parallel and a fourth shut-off valve are arranged between a gas outlet of the dry desulfurization device and a gas inlet of the TSA dehydration device;
a power generation device is arranged between a gas outlet of the TSA dehydration device and a gas inlet of the dry desulfurization device;
a gas outlet of the first carbon dioxide PSA adsorption device is connected to the second heat exchanger, and the second heat exchanger is connected to a blast furnace;
a gas outlet of the second carbon dioxide PSA adsorption device is connected to a gas inlet of the first carbon dioxide PSA adsorption device;
an eighth shut-off valve is arranged between the third heat exchanger and the carbon dioxide high-pressure storage tank;
a gas outlet of the third heat exchanger is connected to a carbon dioxide liquefaction storage device, and a seventh shut-off valve is arranged between the third heat exchanger and the carbon dioxide liquefaction storage device;
a ninth shut-off valve is arranged between the carbon dioxide high-pressure storage tank and the fourth heat exchanger;
gas discharged from the expansion power generation device further passes through the fourth heat exchanger before entering the fifth heat exchanger; and
a gas outlet of the fifth heat exchanger is connected to a gas inlet of the second carbon dioxide PSA adsorption device.

Optionally, the dust removal unit includes a gravity dust removal device and a bag dust removal device arranged in sequence.

Optionally, the power generation device between the gas outlet of the temperature swing adsorption dehydration device and the gas inlet of the dry desulfurization device is a blast furnace gas top pressure recovery turbine (TRT) power generation device.

A second technical scheme of the present disclosure is to provide an operation method for the above-mentioned blast furnace gas pressure swing adsorption carbon dioxide capture system coupled with compressed energy storage, including the following steps:
during a electricity consumption valley period, performing carbon dioxide compression energy storage; in a stage of performing the carbon dioxide compression energy storage, opening the second shut-off valve, the third shut-off valve and the eighth shut-off valve, and closing the first shut-off valve, the fourth shut-off valve, the seventh shut-off valve and the ninth shut-off valve; dedusting blast furnace gas through the dust removal unit, and desulfurizing the blast furnace gas by the dry desulfurization device, then dehydrating the blast furnace gas by the TSA dehydration device through the first heat exchanger; then adsorbing carbon dioxide by the first carbon dioxide PSA adsorption device, and returning waste gas to the blast furnace through the second heat exchanger; desorbing the carbon dioxide adsorbed by the first carbon dioxide PSA adsorption device, then compressing the carbon dioxide by the first compressor and introducing the carbon dioxide into the second carbon dioxide PSA adsorption device for carbon dioxide adsorption, and introducing the waste gas into the first carbon dioxide PSA adsorption device; and desorbing the carbon dioxide adsorbed by the second carbon dioxide PSA adsorption device, then compressing the carbon dioxide by the second compressor, the second heat exchanger and the third heat exchanger, and compressing and storing the carbon dioxide in the carbon dioxide high-pressure storage tank; and
during a electricity consumption peak period, performing expansion power generation with the compressed and stored carbon dioxide, and liquefying and storing the carbon dioxide after concentration; in a stage of performing the expansion power generation with the compressed and stored carbon dioxide, and liquefying and storing the carbon dioxide after the concentration, opening the first shut-off valve, the fourth shut-off valve, the seventh shut-off valve and the ninth shut-off valve, and closing the second shut-off valve, the third shut-off valve and the eighth shut-off valve; dedusting the blast furnace gas through the dust removal unit, then heating and regenerating an adsorbent in the TSA dehydration device by passing the blast furnace gas through the jacket of the TSA dehydration device, then generating power by the power generation device, and introducing the blast furnace gas into the dry desulfurization device for desulfurization, then dehydrating the blast furnace gas by the TSA dehydration device; then introducing the blast furnace gas into the first carbon dioxide PSA adsorption device for the carbon dioxide adsorption, returning the waste gas to the blast furnace through the second heat exchanger; desorbing the carbon dioxide adsorbed by the first carbon dioxide PSA adsorption device, then compressing the carbon dioxide by the first compressor and introducing the carbon dioxide into the second carbon dioxide PSA adsorption device for the carbon dioxide adsorption, and introducing the waste gas into the first carbon dioxide PSA adsorption device; purging and desorbing the carbon dioxide adsorbed by the second carbon dioxide PSA adsorption device, then compressing the carbon dioxide by the second compressor, the second heat exchanger and the third heat exchanger, and introducing the carbon dioxide into the carbon dioxide liquefaction storage device for liquefaction and storage; and using a purge gas for the purging and desorbing, where the purge gas is obtained by releasing high-pressure carbon dioxide stored in the carbon dioxide high-pressure storage tank through the fourth heat exchanger, introducing the high-pressure carbon dioxide into the expansion power generation device for the expansion power generation, and then passing the high-pressure carbon dioxide through the fourth heat exchanger and the fifth heat exchanger.

In the present disclosure, the first carbon dioxide PSA adsorption device and the second carbon dioxide PSA adsorption device each contain multiple adsorption towers. These adsorption towers operate independently, and may simultaneously perform carbon dioxide adsorption and desorption.

Utilizing the blast furnace gas pressure swing adsorption carbon dioxide capture system coupled with compressed energy storage of the present disclosure:
from an energy storage perspective, under the same conditions, because the CO₂ molecule has a larger molecular mass (44 grams per mole, compared to air's 28 grams per mole), the energy density of CO₂ under high pressure is higher than that of air. Compared to compressed air energy storage, using the high-concentration CO₂ enriched from blast furnace gas for compressed energy storage may increase the energy storage density by 10% to 20%, from 30 kilowatt-hours per cubic meter to 33-36 kilowatt-hours per cubic meter; and
for the pressure swing adsorption carbon capture process, the adsorption capture process mainly consumes electricity, accounting for over 90% of the total energy consumption. By utilizing the residual pressure of blast furnace gas during electricity consumption valley periods, the energy consumption for compressing the feed gas for pressure swing adsorption device 1 may be saved. It is expected to reduce the electricity consumption of the pressure swing adsorption carbon capture process by 20% to 30%, enabling the operating power of the PSA system to be reduced from 100 kilowatts to 70-80 kilowatts. Compared to not utilizing the residual pressure of blast furnace gas, when the residual pressure of blast furnace gas is not utilized, the electricity consumption for capturing one ton of CO₂ is 250 kilowatt-hours. After utilizing the residual pressure, the electricity consumption for capturing one ton of CO₂ is reduced to 175-200 kilowatt-hours, and the corresponding electricity cost is reduced by 20% to 30%.

The beneficial technical effects of the present disclosure are as follows.

The present disclosure uses blast furnace gas as a raw material and pressure swing adsorption as the carbon dioxide capture technology. By coupling with compressed energy storage, the present disclosure significantly improves the capture purity and recovery rate of carbon dioxide, enabling high-efficiency and low-cost cyclic capture and storage of carbon dioxide in blast furnace gas.

The present disclosure uses the higher-purity carbon dioxide obtained from blast furnace gas pressure swing adsorption capture as a working medium for energy storage, enabling high-density storage and high-efficiency release of carbon dioxide from blast furnace gas. While increasing the cyclic flow rate and energy storage density of blast furnace gas energy storage, it reduces the electricity consumption and electricity cost of pressure swing adsorption, and lowers the costs of compressed energy storage and pressure swing adsorption carbon dioxide capture.

The present disclosure fully utilizes the high-temperature and high-pressure emission characteristics of blast furnace gas, and regenerates the dehydration adsorbent in the TSA device by heating with high-temperature gas, saving the additional energy consumption required for TSA dehydration. Meanwhile, using heating network return water and gases within the system as heat exchange media, it efficiently utilizes the energy generated within the system, reduces reliance on external energy during the cyclic process, is conducive to reducing system energy consumption, and has good economic benefits.

### BRIEF DESCRIPTION OF THE DRAWINGS

FIG. 1 is a schematic diagram of the operation of the blast furnace gas pressure swing adsorption CO₂ capture system coupled with compressed energy storage in an embodiment of the present disclosure.

FIG. 2 is a schematic diagram of the temperature swing adsorption (TSA) dehydration device in an embodiment of the present disclosure.

FIG. 3 shows the operational flow diagram of the blast furnace gas pressure swing adsorption carbon dioxide capture system coupled with compressed energy storage in the embodiment of the present disclosure when the grid load is in a valley period.

FIG. 4 shows the operational flow diagram of the blast furnace gas pressure swing adsorption carbon dioxide capture system coupled with compressed energy storage in the embodiment of the present disclosure when the grid load is in a peak period.

### DETAILED DESCRIPTION OF THE EMBODIMENTS

Various exemplary embodiments of the present disclosure are described in detail below. This detailed description should not be construed as limiting the disclosure, but should be understood as a more detailed description of certain aspects, characteristics, and embodiments of the disclosure. It should be understood that the terms used in the present disclosure are only for describing specific embodiments and are not intended to limit the disclosure.

Furthermore, for numerical ranges in the present disclosure, each intermediate value between the upper and lower limits of the range should be considered as specifically disclosed. Every intermediate value at any stated value or within any stated range, and every smaller range defined between any intermediate value and any other stated value or intermediate value within the stated range, is also included in the present disclosure. The upper and lower limits of these smaller ranges may be independently included or excluded from the range.

Unless otherwise stated, all technical and scientific terms used herein have the same meaning as commonly understood by one of ordinary skill in the art to which this disclosure belongs. Although only optional methods and materials are described in the present disclosure, any methods and materials similar or equivalent to those described herein may also be used in the practice or testing of the present disclosure.

Regarding the terms “comprising”, “including”, “having”, “containing”, and the like used herein, they are all open-ended terms, meaning including but not limited to.

### Embodiment

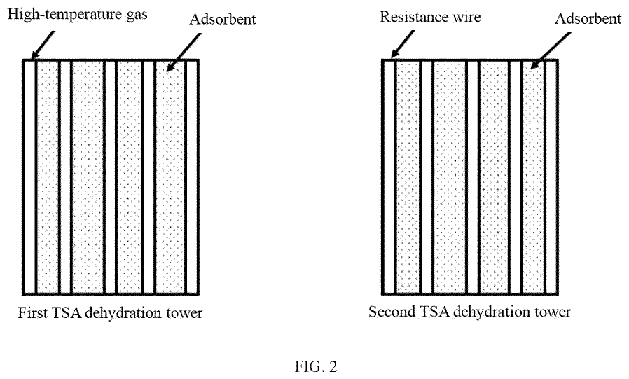

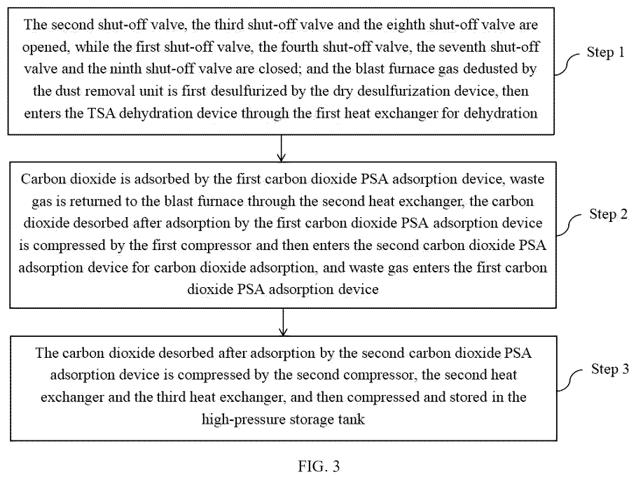

Blast furnace gas is discharged from the top of a blast furnace and then undergoes dust removal through gravity dust removal and bag dust removal. The dust-removed gas has a pressure of 0.2 megapascals and a temperature of 130 to 150 degrees Celsius. When the grid load is in a valley period, the system operates in the carbon dioxide capture and compressed energy storage stage (as shown in FIG. 3). In this stage, the second shut-off valve is opened and the first shut-off valve is closed. The dust-removed blast furnace gas is desulfurized by a dry desulfurization device, then cooled by low-temperature return water from the first heating network water supply port through the third shut-off valve, and subsequently dehydrated by the temperature swing adsorption (TSA) dehydration tower shown in FIG. 2. The dehydrated gas is connected to the gas inlet of the first pressure swing adsorption (PSA) device. In this stage, the fifth shut-off valve is opened and the sixth shut-off valve is closed. The first heat exchanger is used for heat exchange to provide heating and hot water. The high-pressure gas after desulfurization, cooling, and drying enters the first PSA device to improve the carbon dioxide recovery rate. The adsorption tail gas (the first waste gas) is preheated by the second heat exchanger and then returned to the blast furnace. The product gas is compressed by the first compressor and then enters the second PSA for further concentration. The adsorption tail gas (the second waste gas) from the second PSA is returned to the inlet of the first PSA to further improve the carbon dioxide recovery rate. The desorbed product gas (with higher carbon dioxide purity) from the second PSA is pressurized by the second compressor, cooled by the second heat exchanger and the third heat exchanger, and then enters the high-pressure storage tank for storage through the eighth shut-off valve.

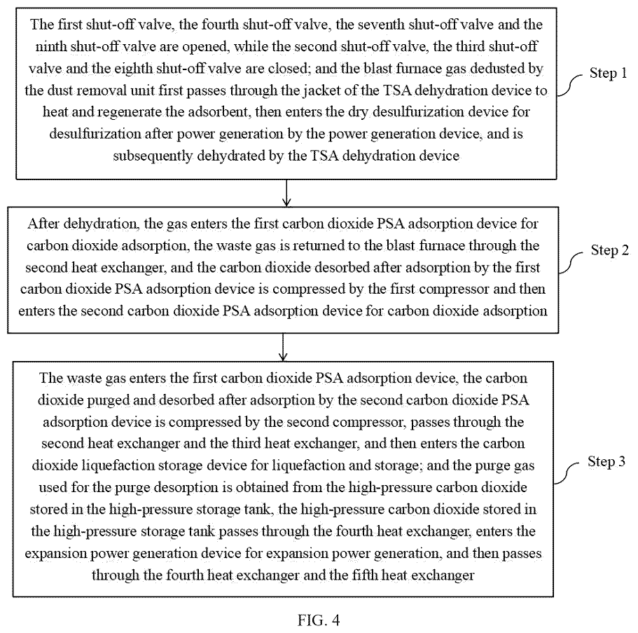

When the grid load is in a peak period, the system operates in the carbon dioxide expansion power generation and concentration stage (as shown in FIG. 4). In this stage, the first shut-off valve is opened and the second shut-off valve is closed. High-temperature gas is used as a heat source and introduced into the jacket of the first TSA dehydration tower shown in FIG. 2 to heat and regenerate the adsorbent. The gas then undergoes power generation by a top pressure recovery turbine (TRT) and subsequently undergoes dry desulfurization, which reduces electricity consumption during grid load peak periods and thereby lowers the comprehensive cost of carbon dioxide capture. In this stage, the fourth shut-off valve and the sixth shut-off valve are opened, while the third shut-off valve and the fifth shut-off valve are closed. The desulfurized gas is dehydrated and then directly undergoes carbon dioxide capture. The return water from the first heating network return water port exchanges heat with the high-temperature carbon dioxide after expansion power generation to provide heating and hot water. The gas after the TRT is low-pressure gas, and carbon dioxide capture is performed at this time with higher purity. The adsorption tail gas (the first waste gas) from the first PSA is preheated by the second heat exchanger and then returned to the blast furnace. The product gas is compressed by the first compressor and then enters the second PSA for further concentration. The adsorption tail gas (the second waste gas) from the second PSA is returned to the inlet of the first PSA to further improve the carbon dioxide recovery rate. Simultaneously, the exhaust gas from expansion power generation is used as purge gas to further increase the carbon dioxide concentration, obtaining high-purity carbon dioxide for liquefaction storage and utilization. The desorbed product gas from the second PSA, subjected to carbon dioxide purging (high-purity carbon dioxide), is pressurized by the second compressor, cooled by the second heat exchanger and the third heat exchanger, and then further compressed, liquefied, and stored for utilization through the seventh shut-off valve. When the grid load is in a peak period, the ninth shut-off valve is opened, and the carbon dioxide stored during the grid load valley period is used for expansion power generation. Before expansion power generation, the carbon dioxide first passes through the fourth heat exchanger to exchange heat with the exhaust gas after expansion power generation, further improving power generation efficiency before entering the expander for power generation. The expanded exhaust gas is cooled by the low-temperature carbon dioxide gas passing through the fourth heat exchanger, and then further cooled by the fifth heat exchanger using return water from the first heating network return water port, before being introduced into the second PSA as purge gas to further enhance the purity of the carbon dioxide product gas.

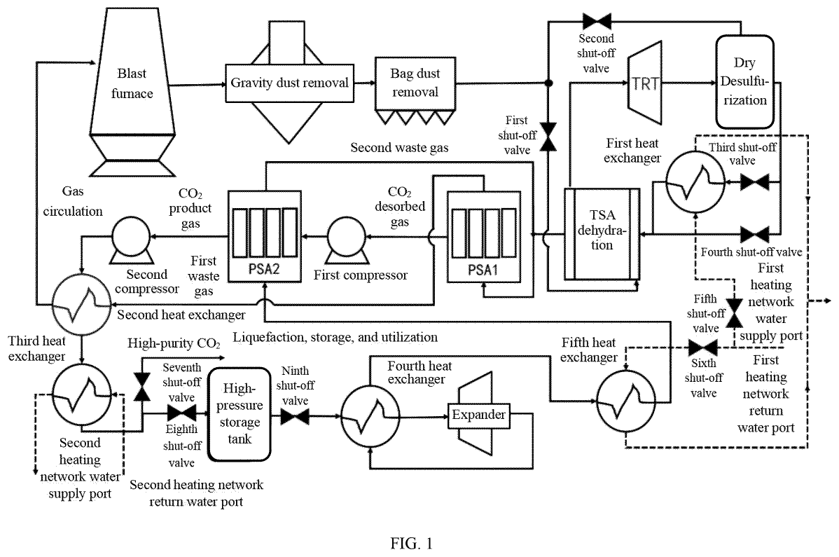

A schematic diagram of the operation of the blast furnace gas pressure swing adsorption CO₂ capture system coupled with compressed energy storage in the embodiment is shown in FIG. 1.

The blast furnace gas pressure swing adsorption carbon dioxide capture system coupled with compressed energy storage of the embodiment is utilized.

From an energy storage perspective, under the same conditions, compared to compressed air energy storage, the use of high-concentration CO₂ enriched from blast furnace gas for compressed energy storage increases the energy storage density by 15%, from 30 kilowatt-hours per cubic meter to 34.5 kilowatt-hours per cubic meter.

For the pressure swing adsorption carbon capture process, the adsorption capture process primarily consumes electricity, accounting for over 90% of the total energy consumption. By utilizing the residual pressure of blast furnace gas during electricity consumption valley periods, the energy consumption for compressing the feed gas for the first PSA may be saved. It is expected that the electricity consumption of the pressure swing adsorption carbon capture process may be reduced by 20%. The operating power of the PSA system may be reduced from 100 kilowatts to 80 kilowatts. Compared to not utilizing the residual pressure of blast furnace gas, when the residual pressure is not utilized, the electricity consumption for capturing one ton of CO₂ is 250 kilowatt-hours. After utilizing the residual pressure, the electricity consumption for capturing one ton of CO₂ is reduced to 200 kilowatt-hours, and the corresponding electricity cost is reduced by 20%.

The embodiments described above are only intended to describe optional modes of the present disclosure and are not intended to limit the scope of the present disclosure. Various modifications and improvements made to the technical schemes of the present disclosure by those of ordinary skill in the art without departing from the design spirit of the present disclosure should fall within the protection scope defined by the claims of the present disclosure.

What is claimed is:

1. A blast furnace gas pressure swing adsorption carbon dioxide capture system coupled with compressed energy storage, comprising: a dust removal unit, a dry desulfurization device, a temperature swing adsorption (TSA) dehydration device, a first carbon dioxide pressure swing adsorption (PSA) adsorption device, a first compressor, a second carbon dioxide PSA adsorption device, a second compressor, a second heat exchanger, a third heat exchanger, a carbon dioxide high-pressure storage tank, a fourth heat exchanger, an expansion power generation device and a fifth heat exchanger connected in sequence;
wherein the dust removal unit is connected to a jacket of the TSA dehydration device, and a first shut-off valve is arranged between the dust removal unit and the TSA dehydration device;
a second shut-off valve is arranged between the dust removal unit and the dry desulfurization device;
a third shut-off valve and a first heat exchanger connected in parallel and a fourth shut-off valve are arranged between a gas outlet of the dry desulfurization device and a gas inlet of the TSA dehydration device;
a power generation device is arranged between a gas outlet of the TSA dehydration device and a gas inlet of the dry desulfurization device;
a gas outlet of the first carbon dioxide PSA adsorption device is connected to the second heat exchanger, and the second heat exchanger is connected to a blast furnace;
a gas outlet of the second carbon dioxide PSA adsorption device is connected to a gas inlet of the first carbon dioxide PSA adsorption device;
an eighth shut-off valve is arranged between the third heat exchanger and the carbon dioxide high-pressure storage tank;
a gas outlet of the third heat exchanger is connected to a carbon dioxide liquefaction storage device, and a seventh shut-off valve is arranged between the third heat exchanger and the carbon dioxide liquefaction storage device;
a ninth shut-off valve is arranged between the carbon dioxide high-pressure storage tank and the fourth heat exchanger;
gas discharged from the expansion power generation device further passes through the fourth heat exchanger before entering the fifth heat exchanger; and
a gas outlet of the fifth heat exchanger is connected to a gas inlet of the second carbon dioxide PSA adsorption device.

2. The blast furnace gas pressure swing adsorption carbon dioxide capture system coupled with the compressed energy storage according to claim 1, wherein the dust removal unit comprises a gravity dust removal device and a bag dust removal device arranged in sequence.

3. The blast furnace gas pressure swing adsorption carbon dioxide capture system coupled with the compressed energy storage according to claim 1, wherein the power generation device between the gas outlet of the TSA dehydration device and the gas inlet of the dry desulfurization device is a blast furnace gas top pressure recovery turbine power generation device.

4. An operation method for the blast furnace gas pressure swing adsorption carbon dioxide capture system coupled with the compressed energy storage according to claim 1, comprising following steps:
during a electricity consumption valley period, performing carbon dioxide compression energy storage; in a stage of performing the carbon dioxide compression energy storage, opening the second shut-off valve, the third shut-off valve and the eighth shut-off valve, and closing the first shut-off valve, the fourth shut-off valve, the seventh shut-off valve and the ninth shut-off valve; dedusting blast furnace gas through the dust removal unit, and desulfurizing the blast furnace gas by the dry desulfurization device, then dehydrating the blast furnace gas by the TSA dehydration device through the first heat exchanger; then adsorbing carbon dioxide by the first carbon dioxide PSA adsorption device, and returning waste gas to the blast furnace through the second heat exchanger; desorbing the carbon dioxide adsorbed by the first carbon dioxide PSA adsorption device, then compressing the carbon dioxide by the first compressor and introducing the carbon dioxide into the second carbon dioxide PSA adsorption device for carbon dioxide adsorption, and introducing the waste gas into the first carbon dioxide PSA adsorption device; and desorbing the carbon dioxide adsorbed by the second carbon dioxide PSA adsorption device, then compressing the carbon dioxide by the second compressor, the second heat exchanger and the third heat exchanger, and compressing and storing the carbon dioxide in the carbon dioxide high-pressure storage tank; and
during a electricity consumption peak period, performing expansion power generation with the compressed and stored carbon dioxide, and liquefying and storing the carbon dioxide after concentration; in a stage of performing the expansion power generation with the compressed and stored carbon dioxide, and liquefying and storing the carbon dioxide after the concentration, opening the first shut-off valve, the fourth shut-off valve, the seventh shut-off valve and the ninth shut-off valve, and closing the second shut-off valve, the third shut-off valve and the eighth shut-off valve; dedusting the blast furnace gas through the dust removal unit, then heating and regenerating an adsorbent in the TSA dehydration device by passing the blast furnace gas through the jacket of the TSA dehydration device, then generating power by the power generation device, and introducing the blast furnace gas into the dry desulfurization device for desulfurization, then dehydrating the blast furnace gas by the TSA dehydration device; then introducing the blast furnace gas into the first carbon dioxide PSA adsorption device for the carbon dioxide adsorption, returning the waste gas to the blast furnace through the second heat exchanger; desorbing the carbon dioxide adsorbed by the first carbon dioxide PSA adsorption device, then compressing the carbon dioxide by the first compressor and introducing the carbon dioxide into the second carbon dioxide PSA adsorption device for the carbon dioxide adsorption, and introducing the waste gas into the first carbon dioxide PSA adsorption device; purging and desorbing the carbon dioxide adsorbed by the second carbon dioxide PSA adsorption device, then compressing the carbon dioxide by the second compressor, the second heat exchanger and the third heat exchanger, and introducing the carbon dioxide into the carbon dioxide liquefaction storage device for liquefaction and storage; and using a purge gas for the purging and desorbing, wherein the purge gas is obtained by releasing high-pressure carbon dioxide stored in the carbon dioxide high-pressure storage tank through the fourth heat exchanger, introducing the high-pressure carbon dioxide into the expansion power generation device for the expansion power generation, and then passing the high-pressure carbon dioxide through the fourth heat exchanger and the fifth heat exchanger.
